(19) United States
(12) Patent Application Publication
(10) Pub. No.: US 2004/0130562 A1
(43) Pub. Date: Jul. 8, 2004

(54) Method of and apparatus for controlling image display

(75) Inventor: Yong-Jun Yoo, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/701,179

(22) Filed: Nov. 5, 2003

(30) Foreign Application Priority Data
Nov. 8, 2002 (KR) 2002-69260

(51) Int. Cl. G09G 5/02

(52) U.S. Cl. 345/698

(57) ABSTRACT

A method and apparatus for controlling image display are provided. The method includes determining whether display of a first image externally received is requested; if it is determined that the display of the first image is requested, connecting a printer to a monitor; and if it is determined that the display of the first image is not requested, connecting the monitor to a main body.

### CROSS-REFERENCE TO RELATED APPLICATIONS

This application claims the priority of Korean Patent Application No. 2002-69260, filed on Nov. 8, 2002, the disclosure of which is incorporated herein by reference.

### BACKGROUND OF THE INVENTION

1. Field of the Invention

The present invention relates to displaying an image provided to a printer, and more particularly, to a method and apparatus for controlling image display, through which a monitor is selectively connected to a main body or a printer.

2. Description of the Related Art

Recently, printers which can output images independent of a computer have appeared. These printers are used only for image output and have been referred to as photo printers. Such a printer directly receives an image from an image storage medium (e.g., a flash memory card) in a digital camera by way of an interface, and then prints the image. Also, multi function peripherals (MFP), which can print images independent of computers, have been used. An MFP, generally includes a scanner, which can read images, and a copier, in addition to a printer, which can print images. An MFP can also receive images from an image storage medium through an interface and then print the image.

When using a printer or an MFP to print a desired image from among a plurality of images stored in an image storage medium, the following methods are used.

In a first method, a user checks the file names of images one by one in a camera apparatus such as a digital camera. The user then selects the file name of an image to be printed by a printer. However, normal users often do not have sufficient knowledge of image file names to recognize the file names of their desired images. Moreover, since a printed state of an image cannot be checked prior to printing, an actual printed image needs to be checked, causing printing paper to be wasted.

In a second method, information about a particular image is stored in an image storage medium using a digital camera, which has a digital print order format (DPOF) function, standard in the field of digital cameras, and then only that particular image is printed using the printer. However, most users are not familiar with this function and feel uncomfortable using it. Moreover, since the printed state of an image cannot be previewed, an actual printed image needs to be checked, which causes printing paper and time to be wasted.

In a third method, a plurality of images are printed on a single sheet so that a user can select an image to be printed. The third method alleviates user inconvenience, but this method also wastes paper. Moreover, as small images are printed on a single sheet in order to minimize paper consumption, therefore it is difficult for users to distinguish similar images from each other.

In a fourth method, an image display device is provided in a printer so that a user can select a desired image through the image display device. This method is very efficient in that user inconvenience is eliminated and the printed state of an image can be checked without actually printing the image. However, addition of an image display device increases the price of these printers.

In order to overcome at least the above-described problems, a method of connecting a printer to a widely available display device, e.g., a television or a computer monitor, has been proposed. In this method, images provided from the image storage medium of a digital camera are displayed on a display device, and then a user checks the displayed images and then selects and prints a desired image. However, in order to connect a monitor that has been connected to the main body of a computer to a printer, a user needs to manually disconnect a monitor connection cable from the computer main body and then connect it to the printer. Thereafter, in order to reconnect the monitor to the computer main body, the user needs to again disconnect and connect the printer. Such repetitive disconnecting and connecting activities are troublesome.

### SUMMARY OF THE INVENTION

The present invention provides a method of controlling image display, through which a monitor is automatically connected to either a main body or a printer when the display of an image to be sent to a printer is requested.

An aspect of the present invention utilizes an apparatus to control image display, through which a monitor is automatically connected to a main body or a printer, when an image provided to a printer is to be displayed.

Another aspect of the present invention includes a method of controlling image display. The method includes detecting a request to display a first image that has been externally received. If a display of the first image is requested, a printer is connected to a monitor. If a display of the first image is not requested, the monitor is connected to a main body.

According to another aspect of the present invention, there is an alternate apparatus for controlling image display. The apparatus includes a display request detection unit, which detects if display of a first image is requested and outputs the result of the detection as a detection signal; and a switching unit, which connects a monitor to a printer when the detection signal is received and connects the monitor to a main body when the detection signal is not received.

Additional aspects and/or advantages of the invention will be set forth in part in the description which follows and, in part, will be obvious from the description, or may be learned by practice of the invention.

### BRIEF DESCRIPTION OF THE DRAWINGS

These and other aspects and advantages of the invention will become apparent and more readily appreciated from the following description of the preferred embodiments taken in conjunction with the accompanying drawings in which:

FIG. 1 is a flowchart of a method of controlling image display according to an embodiment of the present invention;

FIG. 2 is a flowchart of an example of operation 14 shown in FIG. 1;

FIG. 3 is a block diagram of an apparatus for controlling image display according to an embodiment of the present invention; and

FIG. 4 is a block diagram of an example of an image processing unit shown in FIG. 3.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

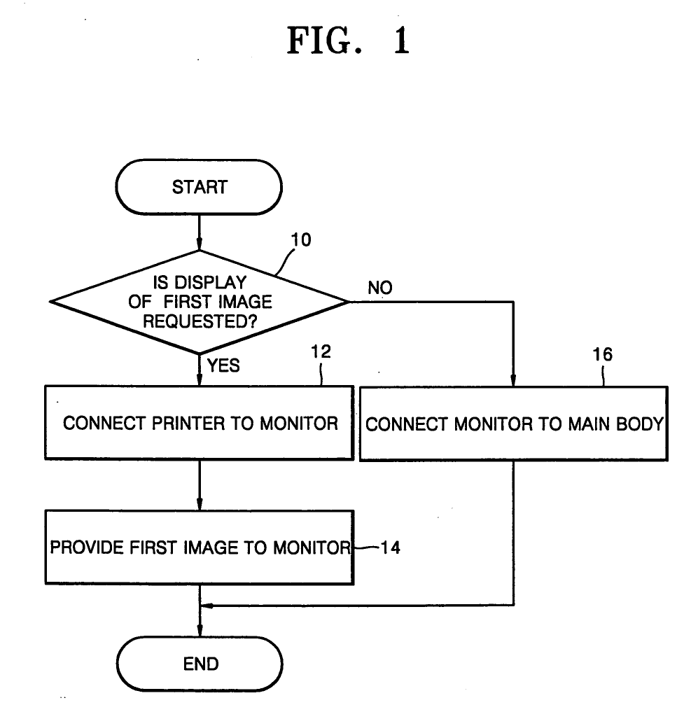

FIG. 1 is a flowchart of a method of controlling image display according to an embodiment of the present invention. The method includes determining whether display of a first image is requested and connecting a monitor to a printer or a main body of a computer in operations 10 through 16.

It is determined in operation 10 whether display of an externally provided first image is requested. The first image may be provided by an image storage medium (not shown) which stores images photographed using a digital camera. However, other media and sources for images can be used. The first image includes a plurality of sub-images. Accordingly, in operation 10, it is determined whether display of all or some of the sub-images in the first image are requested.

If display of the first image is requested in operation 10, the monitor is connected to the printer in operation 12.

The first image is then provided to the monitor in operation 14.

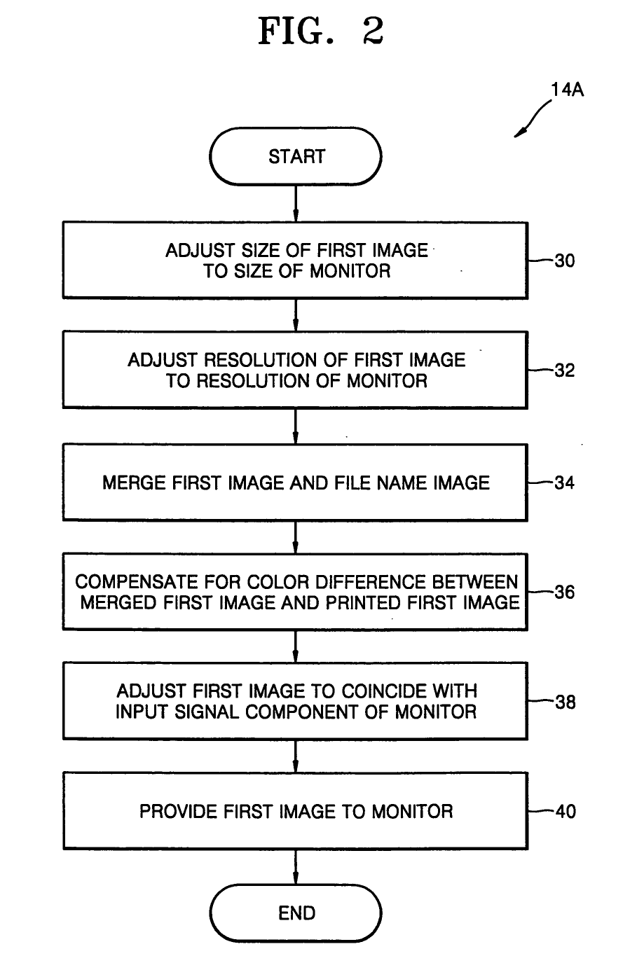

FIG. 2 is a flowchart of an example 14A of operation 14 shown in FIG. 1. The example 14A includes adjusting the size and the resolution of the first image, merging the first image and a file name image, compensating for color difference, and providing the first image to the monitor in operations 30 through 40.

Following operation 12, the size of the first image is adjusted to the size of the monitor in operation 30. The size of the first image is usually greater than that of the monitor. Accordingly, it is necessary to adjust the size of the first image in order to fully display the first image on the monitor.

Next, in operation 32, the resolution of the first image is adjusted to the resolution of the monitor. For instance, an image, which is photographed using a digital camera and then transmitted from the camera's image storage medium, usually has more than one million pixels per frame. However, a display device such as a monitor displays a much smaller number of pixels. Accordingly, it is necessary to adjust the resolution of the first image in order to display the first image on the monitor.

In operation 34, a file name image indicating the resolution-adjusted first image is merged with the first image. To merge the images is to synthesize the images. The file name image indicating the first image represents a term, which distinguishably designates each sub-image from other sub-images in the first image. For example, when one of the sub-images of the first image is an image of an animal, a file name image representing the term “animal” is merged with the corresponding sub-image.

In operation 36, a color difference between the merged first image and a printed image is compensated for. It is usual for the colors of a printed first image to be different from those of a displayed first image. Accordingly, it is necessary to compensate for the color difference between the merged first image and the printed first image.

In operation 38, the compensated first image is adjusted to coincide with an input signal component of the monitor. In order to input the first image to the monitor, the first image needs to be adjusted to coincide with the signal component input to the monitor.

In operation 40, the first image, coinciding with the input signal component of the monitor, is sent to the monitor. Then, the first image is displayed on the monitor, and a user is able to check the displayed first image and decide whether to print the first image.

Alternatively, if a display of the first image is not requested in operation 10 of FIG. 1, the monitor is connected to the main body in operation 16. If the monitor is connected to the main body, the monitor displays a second image provided from the main body according to the control of the main body.

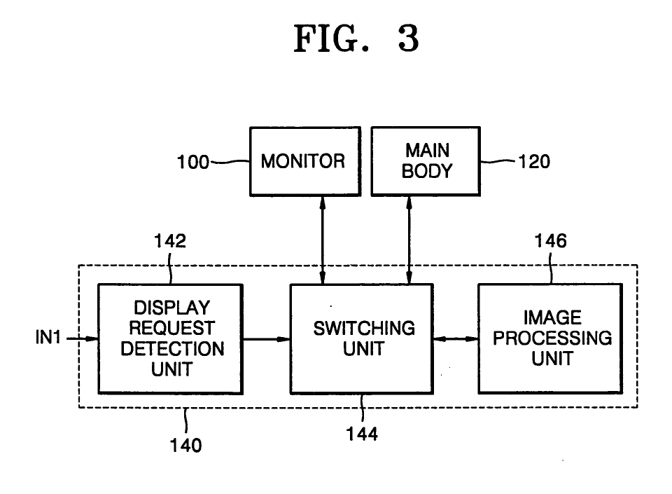

FIG. 3 is a block diagram of an apparatus for controlling image display according to an embodiment of the present invention. The apparatus includes a monitor 100, a main body 120, and a printer 140. The printer 140 includes a display request detection unit 142, a switching unit 144, and an image processing unit 146.

The monitor 100 is a display device, which is usually connected to a computer or similar device. The monitor 100 is connected to the switching unit 144 through a cable. The monitor 100 may be generic, and thus a detailed description thereof will be omitted. However, it is understood that monitor 100 could be any type of display device connected to a computer, such as a display on a personal digital assistant, a display on a mobile phone, or a digital recorder connected to the display.

The main body 120 is, for example, a computer with a central processing unit (CPU) controlling a display function of the monitor 100. The main body 120 is connected to the switching unit 144 through a cable. However, it is understood that wireless techniques can instead be used. The main body 120 may be generic, and thus a detailed description thereof will be omitted.

The printer 140 prints images or text on printing paper. The printer 140 used in the present invention may include a multi function peripheral (MFP). An MFP includes a scanner, which can read images, and a copier, in addition to having the capability of printing images or text. Hereinafter, the printer 140 includes an MFP. However, the printer 140 need not be an MFP according to all aspects of the invention.

While performing operation 10, if the display request detection unit 142 detects a request to display a first image that has been externally transmitted to the printer 140, the display request detection unit 142 outputs a detection signal. For example, when the display request detection unit 142 receives a signal requesting a display of the first image from a user by way of an input terminal IN1, the display request detection unit 142 detects the signal and outputs the result of the detection to the switching unit 144 as the detection signal.

In operation 12 and/or 16, the switching unit 144 connects the monitor 100 to the printer 140 or the main body 120 in response to a detection signal or lack thereof, respectively.

When the detection signal is received from the display request detection unit 142, the switching unit 144 connects the monitor 100 to the printer 140 and continues the connection until the first image is displayed on the monitor 100.

The switching unit 144 is provided with two or more ports, such as connectors for analog monitor cables or connectors for digital display, in order to selectively connect the monitor 100 to the main body 120 or the printer 140.

In operation 14, the image processing unit 146 first receives confirmation that the monitor 100 is connected to the printer 140 from the switching unit 144. The image processing unit 146 then processes the first image as a signal to be displayed on the monitor 100 and outputs the result of processing. Since the first image is an image photographed using a digital camera, data processing or signal processing is required in order to display the first image on the monitor 100. Accordingly, the image processing unit 146 processes the first image as a signal to be displayed on the monitor 100 and outputs the result of processing to the monitor 100 through the switching unit 144.

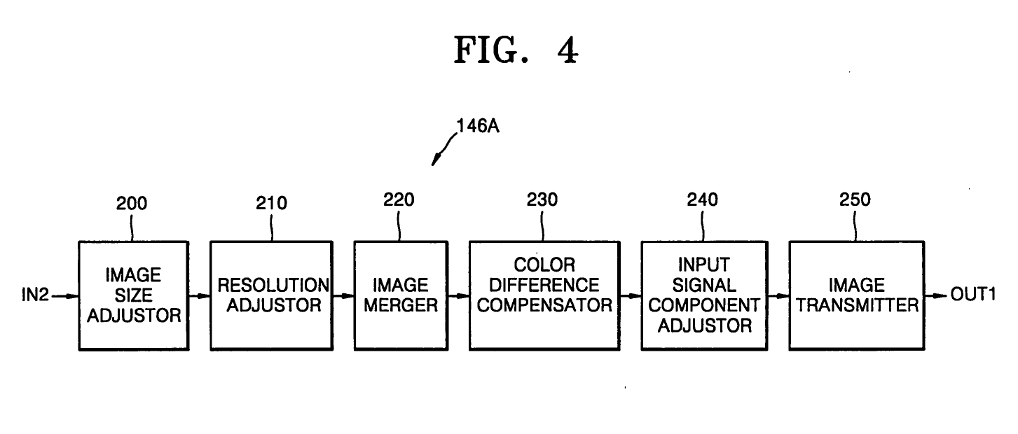

FIG. 4 is a block diagram of an example 146A of the image processing unit 146 shown in FIG. 3. The example 146A includes an image size adjustor 200, a resolution adjustor 210, an image merger 220, a color difference compensator 230, an input signal component adjustor 240, and an image transmitter 250.

In operation 30, the image size adjustor 200 adjusts the size of the first image to the size of the monitor 100 and outputs the size-adjusted first image. The image size adjustor 200 receives the result that the monitor 100 is connected to the printer 140 through an input terminal IN2, adjusts the size of the first image, which is provided from an image storage unit (not shown) of the printer 140 or an image storage medium, to the size of the monitor 100, and outputs the size-adjusted first image to the resolution adjustor 210.

In operation 32, the resolution adjustor 210 adjusts the resolution of the size-adjusted first image to the resolution of the monitor 100 and outputs the resolution-adjusted first image to the image merger 220.

In operation 34, the image merger 220 merges the resolution-adjusted first image with a file name image and outputs the merged first image. The image merger 220 generates the file name image by reading a font stored in a storage unit (not shown) of the printer 140 or referring to a code. The image merger 220 merges the generated file name image with the resolution-adjusted first image and outputs the merged first image to the color difference compensator 230.

In operation 36, the color difference compensator 230 compensates for a color difference between the merged first image and a printed image of the first image. The compensated first image is then output. Two examples of how the color difference compensator 230 performs color difference compensation are the use of gamma correction and/or the use of color matching. Gamma correction adjusts the general color level. Color matching detects and adjusts the most approximate color value for each pixel. However, other correction techniques can be used. The color difference compensator 230 outputs the compensated first image to the input signal component adjustor 240.

In operation 38, the input signal component adjustor 240 adjusts the compensated first image to coincide with an input signal component of the monitor 100 and outputs the adjusted first image. The input signal component adjustor 240 adjusts a red (R) signal, a green (G) signal, a blue (B) signal, a horizontal scan signal, and a vertical scan signal of the first image so that the first image coincides with the input signal component of the monitor 100.

In operation 40, the image transmitter 250 transmits the first image coinciding with the input signal component of the monitor 100 to the monitor 100. The first image transmitted to the monitor 100 is displayed on the monitor 100 so that the user can check the displayed first image.

As described above, according to the present invention, a monitor is automatically connected to a main body or a printer depending on whether display of an image transmitted to the printer is requested, eliminating users inconvenience in manually connecting the monitor to the printer or the main body.

In an additional aspect of the invention the apparatus may be a stand alone component, such that a printer, a monitor, and a main body are separately connected to the apparatus. The apparatus may also have connection ports for various image input devices such as laptop computers, PDAs, digital cameras, cellular phones, storage disks, memory sticks, or various forms of flash media.

In another aspect of the invention, the apparatus may be integrated into a storage cradle for an electronic device such as a PDA or a cellular phone.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of controlling image display performed by a printer, which provides an externally received first image to a monitor that displays the first image and/or a second image provided from a main body, the method comprising:
determining whether display of the first image is requested;
if it is determined that the display of the first image is requested, connecting the printer to the monitor; and
if it is determined that the display of the first image is not requested, connecting the monitor to the main body.

2. The method of claim 1, further comprising providing the first image to the monitor after the printer is connected to the monitor.

3. The method of claim 2, wherein the providing the first image to the monitor comprises:
adjusting a size of the first image to a size of the monitor;
compensating for a color difference between the size-adjusted first image and a printed image of the first image;
adjusting the compensated first image to coincide with an input signal component of the monitor; and
providing the first image coinciding with the input signal component of the monitor to the monitor.

4. The method of claim 3, wherein the providing the first image to the monitor further comprises adjusting a resolution of the size-adjusted first image to a resolution of the monitor after adjusting the size of the first image to the size of the monitor and prior to compensating for the color difference between the size-adjusted first image and the printed image of the first image.

5. The method of claim 4, wherein the providing the first image to the monitor further comprises merging the resolution-adjusted first image and a file name image indicating the resolution-adjusted first image after adjusting the resolution of the size-adjusted first image to the resolution of the monitor and prior to compensating for the color difference between the size-adjusted first image and the printed image of the first image.

6. The method according to claim 2, wherein the providing the first image to the monitor comprises adjusting a size of the first image to a size of the monitor.

7. The method according to claim 2, wherein the providing the first image to the monitor comprises adjusting a resolution of the first image to a resolution of the monitor.

8. The method according to claim 2, wherein the providing the first image to the monitor comprises merging the first image with a file name image.

9. The method according to claim 2, wherein the providing the first image to the monitor comprises compensating for a color difference between a display of the first image and a printed image of the first image.

10. The method according to claim 2, wherein the providing the first image to the monitor comprises adjusting an input signal component of the first image to coincide with a input signal component of the monitor.

11. The method according to claim 10, wherein the adjusting the input signal component comprises adjusting a red signal, a green signal, a blue signal, a horizontal scan signal, and a vertical scan signal.

12. The method according to claim 2, wherein the providing the first image to the monitor comprises:
adjusting a size of the first image to a size of the monitor;
adjusting a resolution of the first image to a resolution of the monitor;
merging the first image with a file name image;
compensating for a color difference between a display of the first image and a printed image of the first image;
adjusting an input signal component of the first image to coincide with a input signal component of the monitor; and
transferring the first image to the monitor.

13. An apparatus for controlling image display, the apparatus being selectively connected to a printer, that provides a first image to a monitor that displays the first image, and to a main body that provides a second image to the monitor, the apparatus comprising:
a display request detection unit which detects that a display of the first image provided by the printer is requested and outputs a result of the detection as a detection signal; and
a switching unit which selectively connects the monitor to the printer in response to a generation of the detection signal from the display request detection unit, and connects the monitor to the main body if the detection signal is not generated.

14. The apparatus of claim 13, further comprising an image processing unit which receives confirmation that the monitor is connected to the printer from the switching unit, processes the first image as a signal to be displayed on the monitor, and outputs the result of the processing to be displayed on the monitor.

15. The apparatus of claim 14, wherein the image processing unit comprises:
an image size adjustor which adjusts a size of the first image to a size of the monitor and outputs the size-adjusted first image;
a color difference compensator which compensates for a color difference between the size-adjusted first image and a printed image of the first image and outputs the compensated first image;
an input signal component adjustor which adjusts the compensated first image to coincide with an input signal component of the monitor and outputs the first image coinciding with an input signal component of the monitor; and
an image transmitter which transmits the first image coinciding with the input signal component of the monitor to the monitor.

16. The apparatus of claim 15, wherein the image processing unit further comprises a resolution adjustor, which adjusts a resolution of the size-adjusted first image to a resolution of the monitor and outputs the resolution-adjusted first image.

17. The apparatus of claim 16, wherein the image processing unit further comprises an image merger, which merges the resolution-adjusted first image and a file name image indicating the resolution-adjusted first image and outputs the merged first image.

18. A printer, comprising:
a display request detection unit to detect a request to display an image to be printed, and if such a request is detected, to output a request signal;
a switching unit that selectively connects the printer to the monitor when a request signal is received, and if a request signal is not received, connects the main body to the monitor;
an image processing unit to process the image to be displayed; and
a printing unit to print the image.

19. An image display apparatus for displaying an image on an externally attached monitor before printing, comprising:
a main body having a processing unit;
a monitor to display images; and
a printer to print images, the printer comprising;
a display request detection unit to detect a request to display an image to be printed, and if such a request is detected, to output a request signal,
a switching unit that connects the printer to the monitor when a request signal is received, and if a request signal is not received, connects the main body to the monitor,
an image processing unit to process the image to be displayed, and
a printing unit to print the image.

20. An image display apparatus for displaying an image on an externally attached monitor before printing the image on an externally attached printer, comprising:
a display request detection unit to detect a request to display an image to be printed, and if such a request is detected, to output a request signal,
a switching unit that selectively connects the printer to the monitor when a request signal is received, and if a request signal is not received, selectively connects the main body to the monitor,
an image processing unit to process the image to be displayed.
